(19) United States
(12) Patent Application Publication
(10) Pub. No.: US 2023/0144764 A1
(43) Pub. Date: May 11, 2023

(54) LEARNING AND TRAINING MANAGEMENT SYSTEM

(71) Applicant: IntelliMedia Networks, Inc., Leesburg, VA (US)

(72) Inventors: Darshan Sedani, Cerritos, CA (US); Teodros Gessesse, Leesburg, VA (US); Devang Ajmera, Gujarat (IN); Joy Shah, Gujarat (IN); Rajkumar Ramakrishnan, Gujarat (IN)

(73) Assignee: IntelliMedia Networks, Inc., Leesburg, VA (US)

(21) Appl. No.: 17/523,504

(22) Filed: Nov. 10, 2021

(51) Int. Cl. G06Q 50/20; G06N 5/00

(52) U.S. Cl. CPC G06Q 50/205; G06N 5/003

(57) ABSTRACT

An integrated cloud-based software system for learning, training, educational courseware, courseware creation, and courseware management, built as a set of user-accessible modules, operating on a common core infrastructure. The software system provides a set of user-selectable combinations of user software tools and experiences available through a wide range of available interactive display devices such as personal computers, mobile tablets, mobile phones, over-the-top TV systems, and virtual reality headset environments. The software system also enables combining of search results from semantic searches, information sources in said interactive display platforms, including interactive courseware, videos, documents, and virtual environments. The software system common core infrastructure is suitable for deployment worldwide, and end-user components are scalable into the range of simultaneously supporting thousands or millions of student users.

### BACKGROUND

### Field

This disclosure is in the field of the interaction among and between educational software systems, learning systems, courseware management, informational communications and visualization systems, and virtual reality presentation system software, students, teachers, and learning system administrators.

### Description of Related Art

As the Internet has grown in speed and computing power, and with the rise of cloud-based data storage and software as a service, online education has become increasingly enabled. Many efforts at standardizing online education and providing tools to enable multiple kinds of course materials to be mixed together have arisen. A critical threshold has also been reached where networking bandwidth and data transfer speeds of massive amounts of data are now sufficient to allow blending of live data streams. These factors have served to open a wide range of opportunities for designing and serving so-called massive open online courses to students worldwide.

Another convergence of technology is also maturing: the widespread availability of multiple kinds of user devices such as laptop computers, mobile phones, mobile tablets of various kinds, next-generation television program management services (so-called over-the-top (“OTT”) services), and virtual reality devices and related services. These devices are becoming sufficiently commonplace that widespread familiarity with their use is an enabler for convergent inter-operation of such device to enhance information delivery and interactivity. Users of such devices now often possess sufficient skills to be able to operate multiple devices and coordinate information between them with ease.

Taken together, these factors provide opportunities for development of inter-operating education systems which take advantage of multiple information delivery modalities including plain text, interactive text, audio, video, collaborative workspaces, and various combinations of live interactions between students and teachers while sharing and even contributing to information flows displayed on multiple devices simultaneous. However, education systems typically operate on individualized basis with separate and/or different software modules and architectures that do not allow them to interact with each other.

Such new systems serve to enhance learning rates of student, collaboration rates among professionals, and may even serve to enhance the rate of new discoveries in science by scientific research communities. The Learning and Training Management System disclosed hereunder is one such integrative software system in this new genre.

### SUMMARY

According to an embodiment of the disclosure, a system for an integrated learning and training management for improved user experience is provided where the system includes at least one processor and at least one memory to store instructions to cause the at least one processor to perform operation(s).

The at least one processor performs operation(s) to coordinate and control one or a plurality of server-based and user-facing modules of the system which operate on a cloud-based core software infrastructure, manage software tools enabling administrative users of the system and teachers using the system to manage courses offering through the system, integrate one or a plurality of immersive learning applications, providing integrated and functionally interoperating interactive computer displays, document overlays, streaming video, Webpage overlays, and over-the-top TV overlays, manage a mixed-reality framework, combining user virtual-reality experiences with actual reality experiences and displaying of courseware materials, manage a communications software framework enabling online video meetings among multiple parties viewing and interacting with shared or distinct courseware materials or other viewable materials, in full-screen tiled or partial screen tiled or layer-stacked displayed, enable development and posting of complex course materials by teachers and other qualified individuals or entities, store shared resources accessible to users of the system, said resources being viewable through display features of the system, and control access to and sharing of stored data filtered by access criteria with administrators or teachers or learners, or other system users setting such criteria.

According to an embodiment of the disclosure, the at least one processor is configured to provide one or a plurality of semantic search algorithms accessible to the user enabling searching for business intelligence or other materials of value to the user, and control one or a plurality of ontologies stored in LTMS databases, by which semantic searches are guided, and provide semi-autonomous software agent processes continuously evolving and improving said one or the plurality of semantic search algorithms and said one or the plurality of ontologies.

According to an embodiment of the disclosure, multiple instances of the system or any component parts thereof may comprise features including the multiple instances sharing data, the multiple instances sharing common values of operating parameters, the multiple instances sharing patterns of operation, and the multiple instances operating independently or in coordination with each other.

Additional aspects will be set forth in part in the description which follows and, in part, will be apparent from the description, or may be learned by practice of the presented embodiments of the disclosure.

### BRIEF DESCRIPTION OF THE DRAWINGS

The above and other aspects, features, and advantages of certain embodiments of the present disclosure will be more apparent from the following detailed description taken in conjunction with the accompanying drawings, in which:

FIG. 1 is a diagram illustrating a Learning and Training Management System (LTMS) according to an embodiment;

FIG. 2 is a diagram illustrating analytics module(s) and search system(s) according to an embodiment;

FIG. 3 is a diagram illustrating Learning Management System (LMS) functionalities interpreted in terms of user interface navigation elements used to access areas of functionalities, according to an embodiment;

FIG. 4 is a diagram illustrating database elements comprising the LMS role system, according to an embodiment;

FIG. 5 is a diagram illustrating database elements comprising the LMS course modules and related tables, according to an embodiment;

FIGS. 6A, 6B, 6C, 6D, 6E, 6F, 6G and 6H are diagrams illustrating detail database elements comprising the LMS course modules, according to an embodiment;

FIG. 7 is a diagram illustrating system infrastructure and configuration of the LTMS including supporting services, according to an embodiment;

FIG. 8 is a diagram illustrating the LMS in the context of related and supporting services, according to an embodiment;

FIG. 9 is a diagram illustrating one user interface dashboard Web page, in a student viewpoint, according to an embodiment;

FIG. 10 is a first diagram illustrating one user interface dashboard Web page, in a site administration viewpoint, according to an embodiment;

FIG. 11 is a second diagram illustrating one user interface dashboard Web page, in a site administration viewpoint, according to an embodiment.

FIG. 12 is a process illustrating a control process over content presentation of the system, according to an embodiment.

### DETAILED DESCRIPTION

Herein below, various embodiments of the disclosure are described with reference to drawings. Reference is made in detail to embodiments, examples of which are illustrated in the accompanying drawings. In this regard, the embodiments may have different forms and should not be construed as being limited to the descriptions set forth herein. In order to further clearly describe features of the embodiments, descriptions of other features that are well known to one of ordinary skill in the art are omitted here.

An embodiment of the invention is directed to learning and training management system that provides selectable combination of software tools and experiences operating on a common core, multi device, multi operating system and network agnostic infrastructure whereby real time and customizable training experience can be presented to the user. In an embodiment, a set of user-selectable (user-accessible) combinations of software tools and experiences are presented to the user and based on selection by the user, the system allows data from various different information sources to be obtained to generate aggregated or blended training components in real time.

Yet another embodiment of the system allows separate and different information sources, learning applications, streaming services, communication/meeting systems, etc., which typically operate on individualized basis to interact with each other including across multiple mobile, tablet, desktop, TV set top box and smart TV devices (and platforms) communicating via public, private and WiFi networks to create blended training components to provide enhanced learning efficiencies. The Synchronized Functionality Universal Gateway lets a remote user provide a guided (controlled) sharing of information across all devices without requiring traditional screen sharing mechanism. The different information sources are queried to generate customizable training components which provide integrated and functionally interoperating interactive computer displays, document overlays, streaming videos, Webpage overlays, over-the-top TV overlays, etc., for the blended training components in real time.

The system, according to an embodiment, allows one or more users to be presented with guided, controlled or customized content using any device with one or more of the users referring or directing any of the other users to a particular content being presented. According to an embodiment, users are presented with guided view of a particular content or a portion of the content being presented where the users may use different devices and the guided view is according to input of any of the users. Information or content as used herein may include but is not limited to text, graphics audio, video, etc.

Learning and Training Management System (LTMS), also called the Apollo LMS, is a cloud-based integrated software system providing a rich context for education of trainees, employees in enterprise organizations, students in institutional settings, as well as individual students, through the operation of courseware, testing, skills validation and certification, courseware management, and inter-personal interactions of students and teachers in various ways. LTMS is a five-phased system supporting training analysis, design, development, implementation, and evaluation independent of training program design. LTMS includes a range of software types and hardware integrations, operating across and integrating a range of current-generation computing, a semantic search algorithm, display and communications devices, such as desktop and laptop computers, mobile tablets, mobile phones, flat-screen smart TVs, and virtual reality headsets. LTMS enables a wide array of interactions between trainer/teachers and trainee, students, students amongst themselves, course administrators, and system managers.

LTMS provides a context for courseware designed as procedural learning processes in accreditable courses with well-defined, testable performance goals. This courseware can be prebuilt and uploaded to the system in the form of documents, interactive HTML5 online components, audios, 2d/3d/360 degrees videos, and reference materials. Said courseware can also be designed and build within the LTMS system and modified by teachers and course administrators.

Students can sign up for accounts to take courses. Their performance is tracked and stored in a unified database, for access by individual students, teachers, course administrators, and other qualified individuals or institutional entities.

According to an embodiment, LTMS and method comprises the following major software component modules:

a) A cloud-based core infrastructure, integrating and serving the user-facing modules (LTMS Core);

b) A Learning Management System (LMS), providing tools to teachers and administrators for managing courses;

c) An Immersive Learning App (ILA), providing integrated displays and interaction systems for complex courseware, including integration of various combinations of interactive computer displays, document overlays, videos and video overlays, Web page (HTML5) overlays, and over-the-top TV overlays;

d) A virtual reality/mixed-reality framework (MRF), combining a virtual-reality experience with courseware materials;

e) A communications module, called IntelliMeetings (IM), enabling online video meetings with multiple parties in full-screen tiled displays; and

f) A courseware creation module (Studio), enabling development and posting of complex course materials by teachers and other qualified individuals or entities.

While LTMS includes software modules and component architectures including characteristics of which may be found individually, the synergy of the interactions of these combined components provide enhanced learning efficiencies which may be derived from the system as a whole not found elsewhere.

The invention involves a family of solutions directed to the learning and training management market comprising a common core of several software that are in the cloud and/or on devices all orchestrated in a Synchronized Functionality Universal Gateway. The various software applications will then work in concert with mobile, wearable, browser and TV set top box devices making the LTMS platform user-device agnostic. An embodiment of the invention presents a user-selectable (user-accessible) combination of software tools and experiences presented to the user in real-time or in a time-shift (on-demand) either to a single trainee on a mobile or wearable device or to a group of trainees watching on a large screen.

According to an embodiment, the system allows for separate and different information sources, learning applications, streaming services, communication/meeting systems, user interactions, queries to be captured and shared on a one-to-one basis or in a one-to-many basis where content viewing is synchronized in real-time while responses or activities by users are individualized. The invention, for example, allows for the benefits of social learning and training while maintaining the independence of individual learning progress.

Overview of LTMS Core

According to an embodiment, LTMS Core is structured as an application core, surrounded by modular software components, each such component providing specific functionality. LMS operates on a cloud-based infrastructure, characterized by components hosted in various contexts, and related services provided on an as-needed basis. These contexts include cloud-hosting services, static asset storage systems, plugin libraries, and public sub netted internet computer networks. Services provided on an as-needed basis include email service, DNS services, and the like.

LTMS core includes a structured-query-language (SQL) database for unified storage of all relevant system data, a data lifecycle manager for monitoring and controlling data, a semantic search algorithm for finding materials of use to the user, and a cloud monitoring system for controlling the infrastructure as a whole.

Apollo LMS core provides all the infrastructure necessary for implementation of a Learning Management System. It implements key components, operated through the aforementioned plug-ins, further described below, said key components described as follows.

Courses and Activities

According to an embodiment, Apollo LMS course is a sequence of activities and resources grouped into sections. Courses themselves are organized into a hierarchical set of categories within Apollo LMS site. Courses can be categorized as per the user's requirement. According to an embodiment, Apollo LMS courses are categorized in following categories:
Short Courses
Comprehensive Courses
Interactive Courses
Video Courses
Certification Courses
Duration Courses

Users

In Apollo LMS, users are anyone who uses the Apollo LMS system. By way of example, in order to participate in course users, need to be enrolled into course with a given role, such as:
Students
Teachers

Course Enrollment

Enrollment gives user the possibility to participate in course as a student or teacher.

User Functionality
User roles in Apollo LMS: Roles assigned to users give them a set of capabilities in given context. For example: Teacher, Student and Forum moderator are examples of roles.
User's capabilities in Apollo LMS: A capability is a description of some particular Apollo LMS feature. Capabilities are associated with roles. For example, mod/forum:replypost is a capability.
Context: A context is a “space” in the Apollo LMS, such as courses, activity modules, blocks etc.
Permissions: A permission is some value that is assigned for a capability for a particular role. For example, allow or prevent.

Added Facilities
Creation and editing of user profiles: In Apollo LMS, the moment an user creates his account, a profile is created for that user. The user needs to fill in his initial details for completing his profile. The user generally always have the permission to edit his own profile anytime on Apollo LMS.
Groups and cohorts: Cohorts, or site-wide groups, enable all members of a cohort to be enrolled in a course in one action, either manually or synchronized automatically.
Enrollments and access control: Users are generally enrolled into some courses and according to their permission settings and the groups to which they belong, they have limited access on Apollo LMS.

Regarding activity and course completion, the activity completion system allows activities such as Quizzes, SCORM modules, etc. to be marked complete when specified conditions are met.

Navigation, settings and configuration: The Navigation block provide easy access to view various sections of the Apollo LMS site and according to an embodiment includes:
My home—a personalized home page displaying links to the courses a user is associated with and activity information (such as unread forum posts and upcoming assignments)
Site pages—links to site pages and resources from the front page of Apollo LMS
My profile—quick links allowing a user to view their profile, forums posts, blogs and messages as well as manage their private files
My courses—lists (by course shortname) and links to courses the user is associated with. Click the course's shortname to view the front page of the course or use the arrows to navigate quickly to a specific section, resource or activity.

JavaScript Library

User Interface library may be used in the system. According to an embodiment, Apollo LMS is enabled to adopt the Yahoo® User Interface library for loading the additional JavaScript® files required by each page.

Logs and Statistics in Apollo LMS

Statistics in Apollo LMS: The statistics graphs and tables show how many hits there have been on various parts of a particular site during various time frames. According to an embodiment, the Logs and Statistics in Apollo LMS may be enabled to be processed daily at a given time. Log in Apollo LMS: According to an embodiment, Logs in Apollo LMS which pertain to activity reports may be enabled. The Logs may be made available at site level and course level.

The referenced plugins are optional modular components that extend LTMS functionality. There are many different types of plugins, and each plugin type supports a different way to extend core functionality. The LTMS system contains a library of over 370 optionally installable plugins. Additional plugins can be downloaded from an external Plugins directory, or installed manually—and all plugins are considered “optional”, even the ones included the LTMS system. These libraries provide specific functionalities useful in some course contexts and not in others.

According to an embodiment, Plugins are accessed through four layers of Application Programming Interfaces (APIs):

1) Low Level API: In this model, the database tables are accessed through a low level API that knows about all the types, relationships and validation rules for the data in the tables. No permission checking is done at this level for performance and complexity reasons.

2) Component API: The component API defines all the things this plugin can do. Every function in the API performs permission checks and validation on the parameters and return types covered by unit tests. This is the useful API that is used by display pages, or called directly by other components (if it depends on this plugin).

3) External API: The external API is a single class that wraps each function in the Component API. By exposing all the functions in the Component API the construction of new interfaces and apps are enabled that we have never even thought about without requiring changes to the relevant plugin. Covering each external function with a unit test ensures that all parameters and return types are correctly specified. External API functions can be called directly from other dependent plugins or sub-plugins.

4) Webservice API: This is a listing of all the functions in the external API in our plugins file. This allows all these functions to be called from various subsystems of the LTMS.

Specific services which operate from the LTMS core, and are expressed uniformly through administrative access to LTMS core, and through access to LMS, ILA, MRF, IM, and Studio, comprise account setup, account login and logout, establishment and maintenance of two or more devices and user interface context sessions through in-common networking features. These features are designed to operate in a consistent way from one context to another.

According to an embodiment, LTMS codebase mostly follows a transaction script approach. This means that the code logic runs primarily as a single procedure, making calls directly to the database or through the database abstraction layer. A transaction may view some information as organized in a particular way, whereas a different transaction will make changes to its organization and details. Each interaction between a client subsystem and the core server system contains a certain amount of logic. In some cases this can be as simple as displaying information extracted from the database. In others it may involve many steps of validations and calculations, and the return of updates to the database.

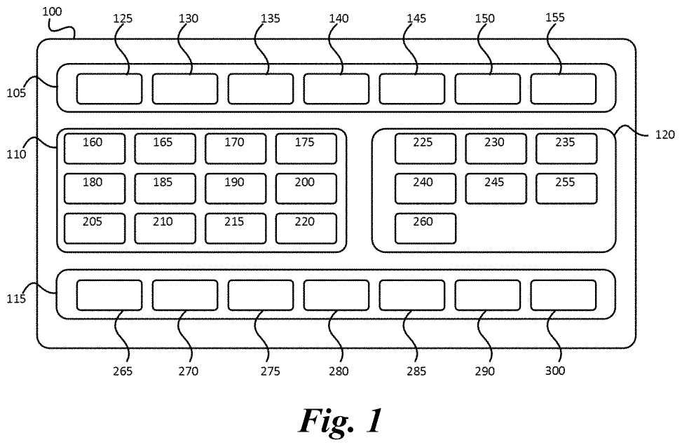

A Learning and Training Management System (LTMS) according to an embodiment is illustrated in FIG. 1. Referring to FIG. 1, LTMS 100 is structured comprising four main block: a range of tools and client software applications 105; shared codebase 110; independently deployable software applications 120; and supporting underlying persistence systems 115. The tools include mobile apps to run on Android® and iOS® (Apple®) platforms 125; a User Experience toolkit and pattern library 130; an API (Application Program Interface) manager 135; configuration tools 140; XBlocks, a cross functional set of tools for building interactive educational courseware (so-called Massive Open Online courses) 145; documentation stores describing the system 150; and core code testing software components 155.

The shared codebase 110 (base code) includes interfacing stub code linking each of the major modules, such as the Learning Management System (LMS) 160; Studio (for developing courseware directly within the LTMS system) 165; XBlock runtime components 170; JavaScript input code 175; student performance assessments module 180; import/export modules for bringing in course materials 185; an event receiver for handling user messages and other events within the system 190; a quarantine facility for errant code 200; user authentication 205; an enrollments module for onboarding students 210; a user dashboard 215; and login and registration code 220. The independently deployed applications 120 are structured comprising programs, i.e., sets of courses 225; a course catalog 230; XQueue, a message queuing module 235; analytics (analytics modules) 240; credential validation 245; a shopping cart checkout system for taking payments 255; and forums for students to share information 260.

The underlying persistence systems 115 include commercially available and open-source software components including but not limited to Amazon® S3, a commercial service for storage of static components 265; caching system such as open source Memcache for caching data during operations 270; a multi-structured commercial database for storing a wide variety of data types and searching effectively 275 such as software Elasticsearch; various kinds of data storage 280 such as MongoDB and database(s) 285 including open source databases/database services such as MySQL; software for inter-process messaging and message queuing 290 such as RabbitMQ; and open source software's Hadoop and Luigi for data pipelining 300. While specific software components, services, databases and functionalities are discussed in association with FIG. 1, the LTMS 100 is not limited to any particular one or specific combination.

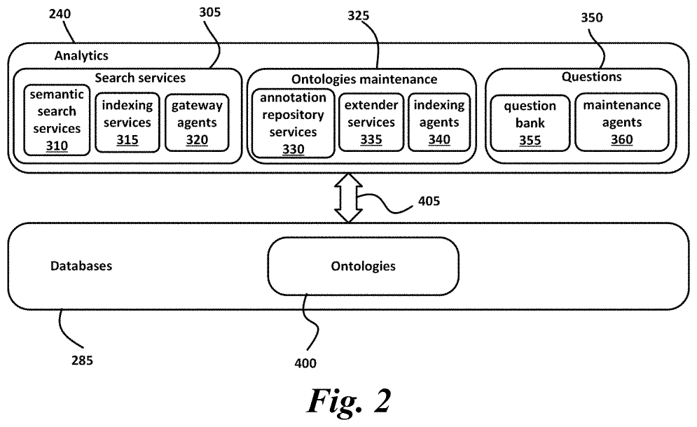

According to an embodiment, a key feature of LTMS is its semantic search subsystem including ontologies representing knowledge domains relevant to a learning system. Referring to FIG. 1, semantic search is largely contained in the analytics (analytics group of modules) 240, together with databases (data storage/LTMS database) 285 for example in MySQL databases. The semantic search subsystem partially follows software architectural guidance from a technology called Holistic Distributed Open Semantic Elaboration (“H-DOSE”), articulated at <http://dose.sourceforge.net/documentation/architecture.html>. The said LTMS semantic search subsystem is implemented in LTMS as shown in FIG. 2. The LTMS database 285 stores one or more ontologies 400, representing knowledge domains of relevance to users of learning systems such as LTMS.

An exemplary analytics module(s) and search system(s) according to an embodiment is illustrated in FIG. 2. As shown in FIG. 2, analytics (analytics modules) 240 contains search services (a search group of software modules) 305, comprising semantic search services 310 which are exposed to system users, indexing services (search indexing services) 315 internal to the LTMS, and gateway agents (semantic search gateway agents) 320. Semantic search gateway agents 320 control the user's access to search functionality, passing messages between and among the user, the search services 310, and the ontologies 400 through inter-process communications pathways 405.

Ontologies are maintained by ontologies maintenance (a group of submodules) 325. Annotations may be added to the ontologies both autonomously and by suitably qualified users through annotation repository services 330. Ontologies are extended by means of autonomous extender services 335. Ontology maintenance is controlled autonomously by indexing agents (ontologies indexing and maintenance agents) 340, acting on ontologies 400 through inter-process communication 405.

Questions are maintained by questions (group of submodules) 350. Questions such as “frequently asked questions” and others, are maintained autonomously or alternatively subject to user control by one or a plurality of question maintenance agents 360. The questions (group of submodules) 350 may also include a question bank 355.

Agents 320, 340, and 360 are software processes which may operate autonomously, maintaining the ontologies and semantic search subsystems in continuously evolving condition, or they may be partially or completely overridden by suitably qualified users.

LMS (Learning Management System) is structured as an application software module of LTMS utilizing key components of the LTMS core, and comprising functional features serving students, teachers, and administrators in managing courses, managing testing systems, skills validation, managing certifications, course import, course setup, course administration, student records management, and data management for all of these said functions.

LMS supports student interaction through user interfaces enabling login/identity verification/logout, opening course(s), purchasing and paying for courses, studying courseware including interactions wherewith, taking tests or examinations as included in courseware, checking test results, obtaining certifications, and managing student-user accounts.

LMS supports teacher interaction through user interfaces enabling login/identity verification/logout, setting up and managing courses, importing course materials from external sources and including such course materials in courseware served to students through LTMS, checking attendance, checking student participation, checking student test results, and providing feedback to students.

LMS supports administrative interaction through user interfaces enabling actions available to teachers, plus administration of system wide databases, managing and administering sets of courses, managing academic calendars applicable to hosted courses, and managing teacher-related information.

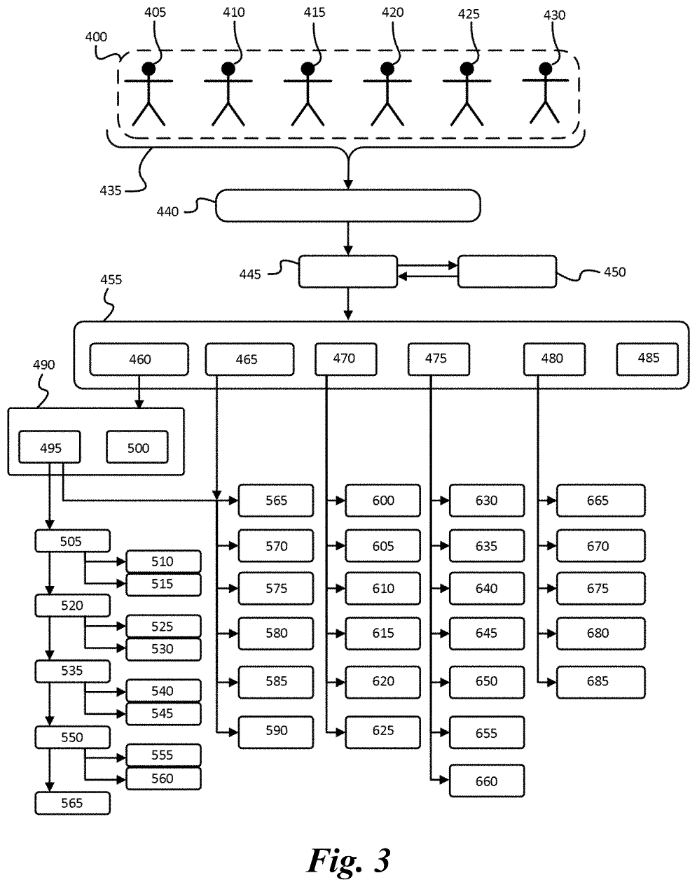

LMS functionalities are illustrated in FIG. 3. The functionalities are interpreted in terms of user interface navigation elements used to access areas of functionalities. The rectangles in FIG. 3 illustrate representation of menu items in a user interface of an embodiment, leading to the corresponding areas of functionality of the system. The arrows represent user interface links from one menu item to another, leading to specific functionalities brought to the fore in the user interface at the endpoints of the sequences of enclosed rectangles.

Any one of six kinds of users, collectively 400, can access the system. They are guests 405, students 410, teachers 415, editing teacher(s) 420 who can modify courses, course creators 425, and system administrators 430. While the users 400 in FIG. 3 are illustrated using six kinds of users, the present invention in not limited to any particular kind/type or number of users.

The users 400 can access the system 435 from the LMS home page 440, either log in 445 or are directed to a signup process 450, and then log in.

According to an embodiment, a user is presented with a main menu 455, comprising the selections of course categories 460, course settings 465, resources 470, activities 475, account management 480, and a site map 485. Each of these menu items is context-sensitive, and may lead to differing further choices depending on the kind of user accessing the system. In general, the choices collectively are as follows.

The course categories 460 may be provided as a menu link which leads to a display of course categories, one of which is shown as a category 490 in FIG. 2. Upon reaching the category 490, the user is presented with a set of courses as course 1, shown as course 495, through course n, shown as 500. Selection of course 495 leads to a set of corresponding lessons, arrayed in sequence as Lesson 1 through Lesson n, shown as lessons 505, 520, 535, and 550. Each lesson has associated with it a set of exercises and a quiz, as for example the lesson shown as 505 has exercises 510, and a quiz 515, the lesson shown as 520 has exercises 525, and a quiz 530, the lesson shown as 535 has exercises 540, and a quiz 545, the lesson shown as 550 has exercises 555, and a quiz 560. The entire course 495 has an exam 565.

Course settings are controlled by editing teachers 420, or course creators 425, or system administrators 430 through the course settings 465 which may be presented as menu with option(s). The settings are grouped and managed by topic 570, lesson frequency 575, course calendar dates 580, assignments 585, types of feedback 590, and enrollment records 595. These settings can be viewed (but not modified) by students 410 from the course interfaces 495, 500.

Resources associated with courses are accessible through resources 470 which may be enabled as context-sensitive resources menu link and comprises documentary resources such as books 605 and journals 610, relevant people 615 including teachers 410, online participatory resources such as wikis 620 and forums 625, and other URLs 600 leading to online tools and external support materials.

Activities 475 which are available through the system are accessible through the context-sensitive menu link, according to an embodiment, which is viewable in the context of relevant courses 495, 500. Activities 475 comprise taking a course 630, doing an assignment related to a course 635, taking a course quiz or exam 640, engaging in a forum discussion 645, engaging in a chat 650 with other relevant individuals, participating in a course workshop 655, and engaging in communications 660 between any combination of system users 405, 410, 415, 425, 425, and 430.

Students 410 or other users 415, 425, 425, and 430 may view or administer their LMS system accounts or those of others as appropriate, comprising aspects of identification 665, contact information 670, courses signed up for 675, course records 680, and attendance records 685.

According to an embodiment, the students 410 or other users 415, 425, 425, and 430 as participants may be guided through content according to indication or direction in real time by an authorized participating user(s).

Database Architecture

The LTMS database architecture is comprising more than 414 tables, according to an embodiment. This architecture has its own abstraction layer, which is a thin wrapper around the various coded database libraries. The database as a whole is an aggregate of core data tables and other tables belonging various plugin modules supporting various ancillary functions. The abstraction layer enables the use of multiple relational database management systems (RDMSs) such as MySQL, PostgresQL, Oracle, and others, by providing translation of standard SQL queries into and out of RDMS-specific formats. Various sets of database tables supporting specific areas of functionality are described in greater detail as follows.

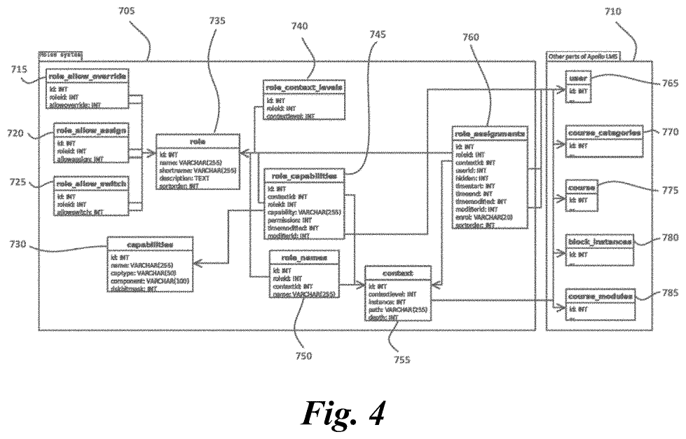

FIG. 4 illustrates database elements comprising the LMS role system, according to an embodiment. As shown in FIG. 4 the role system comprises a group of interacting tables 705 with relationships between them, and other tables 710 in LMS. According to the embodiment, the role_allow_override table 715 stores information on which roles can override which other roles. The role_allow_assign table 720 stores information on which roles can assign which to other roles. The role_allow_switch table 725 stores information on which roles can switch to which other roles. The capabilities table 730 stores the various permissions that can be granted. The role table 735 defines a role, its name, etc. Other parts of the role 735 definition are stored in the role_capabilities 745 and role_context_levels 740 tables. The role_names table 750 stores information used to implement the feature where roles can be given different names in different courses (or, more generally, contexts). A context 755 is a scope in LMS system, for example the whole system, a course, a particular activity. The type is given by contextlevel, 755 and depending on context level, instanceid 755 points to one of a number of different tables. The role_assignments table 760 stores information on which users are assigned which roles in which contexts. The role system interoperates with external tables in other parts 710 of the LTMS system, including a user table 765, a course_categories table 770, a course table 775, a block_instances table 780, and a course_modules table 785.

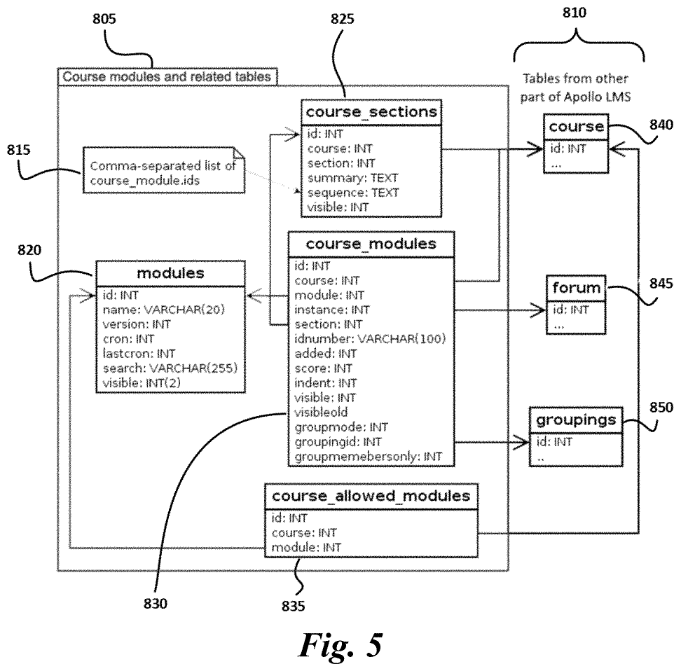

FIG. 5 is a diagram illustrating database elements comprising the LMS course modules and related tables, according to an embodiment. FIG. 5 illustrates the course modules 805 and the relationships between them, and other tables in the LMS. The course sections table 825 defines a course, its summary, etc. Other parts of the course_modules 815 are stored as comma separated list in sequence of course_sections 825. It refers to course table 840 which is other parts of LMS tables 810. The course_modules table 830 defines a course, modules, groupmode, its scores, etc. Other parts of the course_modules 815 are stored as comma separated list in sequence of course_sections 825. The course_allowed_modules table 835 defines a course, its modules, etc. It refers to course table 840 which is in other parts of LMS tables 810. The modules table 820 defines a course, its modules, etc. It refers to course table 840 which is other parts of LMS tables 810. The course table 840, forum table 845, and groupings table 850 defined in other tables 810 from the LMS system has references from course sections 825, course_modules 830 and course_allowed_modules 835 as part of the course module and other related tables 805.

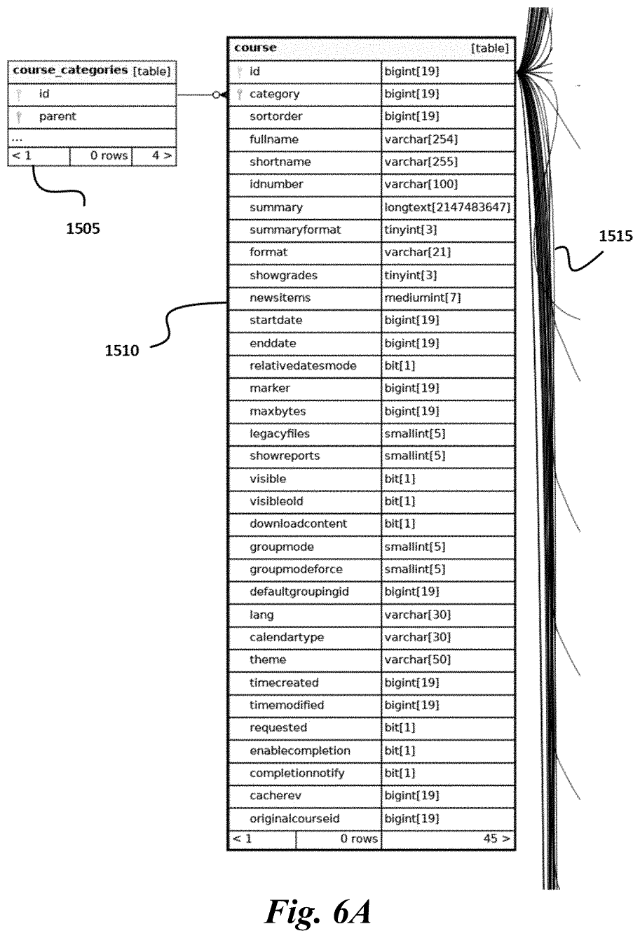

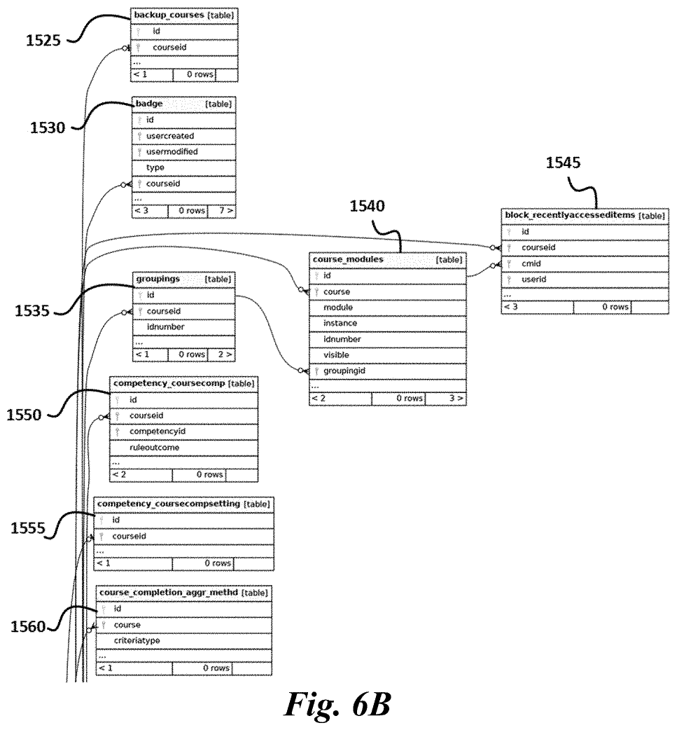

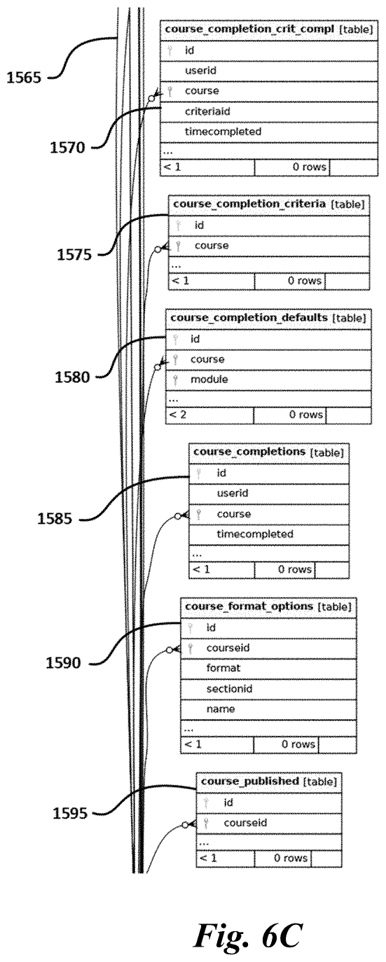

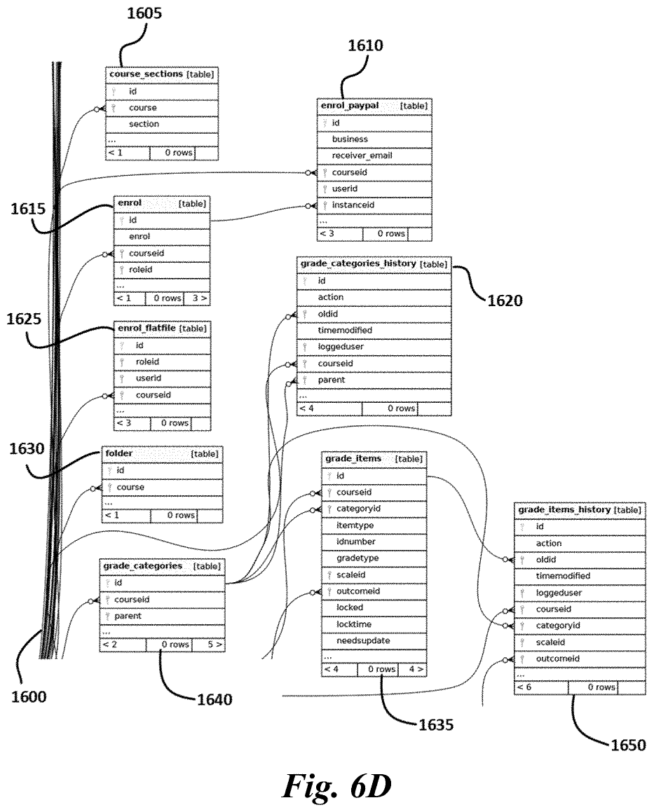

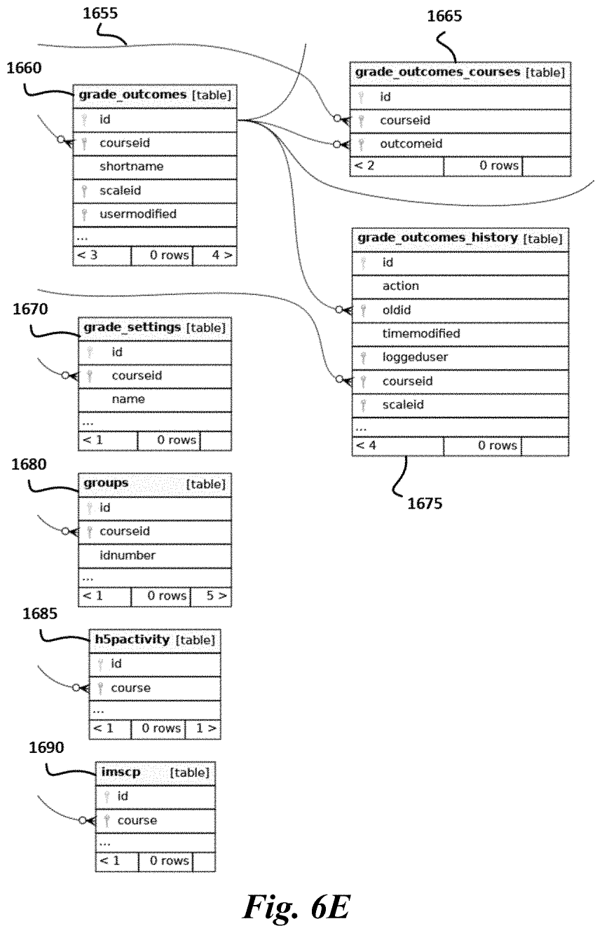

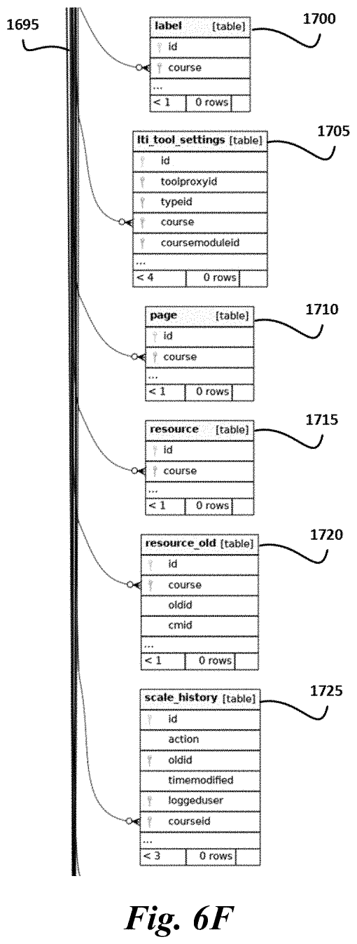

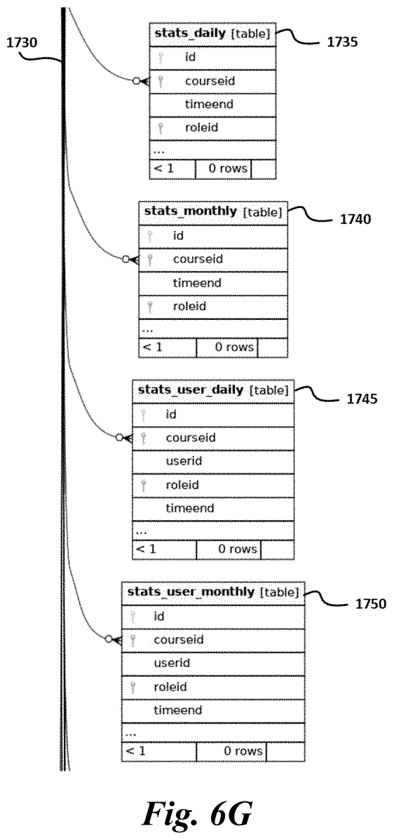

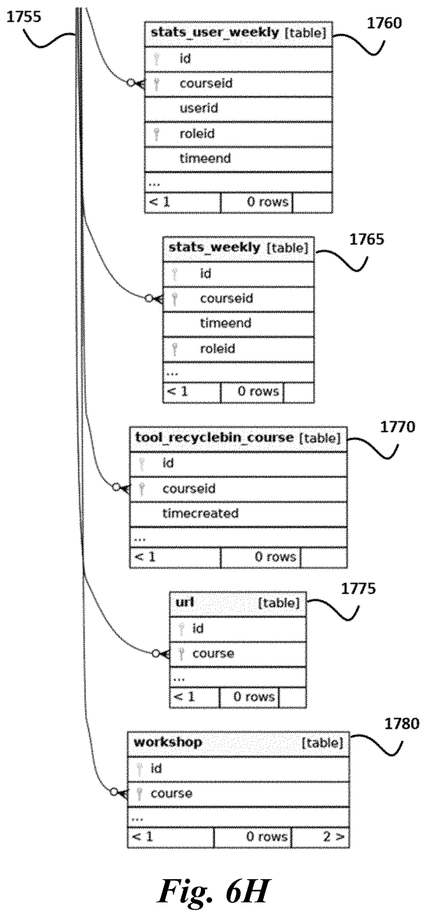

FIGS. 6A, 6B, 6C, 6D, 6E, 6F, 6G and 6H are diagrams illustrating detail database elements comprising the LMS course modules, according to an embodiment. FIGS. 6A, 6B, 6C, 6D, 6E, 6F, 6G and 6H illustrate the database tables and relationships for the course system. Unless otherwise specified, each table in FIGS. 6B through 6H are related to the course table 1510.

FIG. 6A illustrates the table course_categories 1505, linked to the key course table 1510, and which is linked 1515 to the tables of the course system, further illustrated in FIGS. 6B through 6H. The diagram in FIG. 6B shows a subset of the tables which are related to the key table course 1510 and other tables. The table backup_courses 1525 stores the reference/links to the backup files of the courses. The table badge 1530 stores the details of badges defined in the courses.

The groupings 1535, table groupings, stores the reference details of groups defined in the course module. Its relationship is set to the table course_modules 1540. The table course_modules 1540 stores the reference details of groups, courses, modules etc defined in the course module. Its relationship is set to the main course table 1510 along with groupings 1535. The table block_recentlyaccesseditems 1545 stores the reference details of userid, courseid etc defined in the table. Its relationship is set to the main course table 1510 along with course_modules 1540. The table competency_coursecomp 1550 stores the reference details of competencyid, coursed, ruleoutcome etc defined in the table. Its relationship is set to the main course table 1510. The table competency_coursecompsetting 1555 stores the reference details of courseid etc defined in the table. Its relationship is set to the main course table 1510. The table course_completion_aggr_methd 1560 stores the reference details of course, criteriatype, etc defined in the table. Its relationship is set to the main course table 1510.

The diagram in FIG. 6C shows the tables which are related to the key table of course and other tables and the relationships between them, and other tables in the LMS. The table 1565 refers to main course table FIG. 6A 1510. The link branch is defined in FIG. 6D 1600. The table course_completion_crit_compl 1570 stores the reference details of course, criteriatype, etc defined in the table. Its relationship is set to the main course table 1510 through the link reference 1565. The table course_completion_criteria 1575 stores the reference details of course is defined in the table. Its relationship is set to the main course table 1510 through the link reference 1565. The table course_completion_default 1580 stores the reference details of course, module, etc is defined in the table. Its relationship is set to the main course table 1510 through the link reference 1565. The table course_completion 1585 stores the reference details of timecompleted, course, etc is defined in the table. Its relationship is set to the main course table 1510 through the link reference 1565. The table course_format_options 1590 stores the reference details of courseid, format, etc is defined in the table. Its relationship is set to the main course table 1510 through the link reference 1565. The table course_published 1595 stores the reference details of courseid is defined in the table. Its relationship is set to the main course table 1510 through the link reference 1565.

FIG. 6D illustrates tables which are related to the key table of course and other tables and the relationships between them, and other tables in the LMS. The table 1600 refers to main course table FIG. 6A 1510. The link branch is defined in FIG. 6D 1600. The table course_section 1605 stores the reference details of course, section, etc defined in the table. Its relationship is set to the main course table 1510 through the link reference 1600. The table enrol_paypal 1610 stores the reference details of business, courseid, etc are defined in the table. Its relationship is set to the main course table 1510 through the link reference 1600. The table enrol 1615 stores the reference details of enrol, roleid, etc is defined in the table. Its relationship is set to the main course table 1510 through the link reference 1600. The table grade_categories_history 1620 stores the reference details of action, courseid, etc is defined in the table. Its relationship is set to the main course table 1510 through the link reference 1600. The table enrol_flatfile 1625 stores the reference details of courseid, roleid, etc is defined in the table. Its relationship is set to the main course table 1510 through the link reference 1600. The table folder 1630 stores the reference details of course is defined in the table. Its relationship is set to the main course table 1510 through the link reference 1600. The table grade_items 1635 store the reference details of courseid, categoryid, etc is defined in the table. Its relationship is set to the main course table 1510 through the link reference 1600. The table grade_categories 1640 store the reference details of courseid, parent, etc is defined in the table. Its relationship is set to the main course table 1510 through the link reference 1600. The table grade_items_history 1650 stores the reference details of coursed, timemodified, etc is defined in the table. Its relationship is set to the main course table 1510 through the link reference 1600.

FIG. 6E illustrates the tables which are related to the key table of course and other tables and the relationships between them, and other tables in the LMS. Table 1655 refers to main course table FIG. 6A 1510. The link branch is defined in FIG. 6D 1600. The table grade_outcomes 1660 stores the reference details of courseid, scaleid, etc defined in the table. Its relationship is set to the main course table FIG. 6A 1510 through the link reference defined in FIG. 6D 1600. The table grade_outcomes_courses 1665 stores the reference details of outcomeid, courseid, etc are defined in the table. Its relationship is set to the main course table FIG. 6A 1510 through the link reference defined in FIG. 6D 1600. The table grade_settings 1670 stores the reference details of courseid, name, etc is defined in the table. Its relationship is set to the main course table FIG. 6A 1510 through the link reference defined in FIG. 6D 1600. The table grade_outcomes_history 1675 stores the reference details of action, courseid, etc is defined in the table. Its relationship is set to the main course table FIG. 6A 1510 through the link reference defined in FIG. 6D 1600. The table groups 1680 stores the reference details of courseid, idnumber, etc is defined in the table. Its relationship is set to the main course table FIG. 6A 1510 through the link reference defined in FIG. 6D 1600. The table h5pactivity 1685 stores the reference details of course is defined in the table. Its relationship is set to the main course table FIG. 6A 1510 through the link reference defined in FIG. 6D 1600. The table imscp 1690 stores the reference details of course is defined in the table. Its relationship is set to the main course table FIG. 6A 1510 through the link reference defined in FIG. 6D 1600.

The diagram in FIG. 6F further illustrates the tables which are related to the key table of course and other tables and the relationships between them, and other tables in the LMS. Table 1695 refers to main course table FIG. 6A 1510. The link branch is defined in FIG. 6D 1600. The table labels 1700 stores the reference details of course which is defined in the table. Its relationship is set to the main course table FIG. 6A 1510 through the link 1695 reference defined in FIG. 6D 1600. The table lti_tool_settings 1705 stores the reference details of toolproxyid, course, etc are defined in the table. Its relationship is set to the main course table FIG. 6A 1510 through the link 1695 reference defined in FIG. 6D 1600. The table page 1710 stores the reference details of course is defined in the table. Its relationship is set to the main course table FIG. 6A 1510 through the link 1695 reference defined in FIG. 6D 1600. The table resource 1715 stores the reference details of course is defined in the table. Its relationship is set to the main course table FIG. 6A 1510 through the link 1695 reference defined in FIG. 6D 1600. The table resource old 1720 stores the reference details of course, cmid, etc is defined in the table. Its relationship is set to the main course table FIG. 6A 1510 through the link 1695 reference defined in FIG. 6D 1600. The table scale_history 1725 stores the reference details of action, coursed, etc is defined in the table. Its relationship is set to the main course table FIG. 6A 1510 through the link 1695 reference defined in FIG. 6D 1600.

FIG. 6G further illustrates the tables which are related to the key table of course and other tables and the relationships between them, and other tables in the LMS. Table 1730 refers to main course table FIG. 6A 1510. The link branch is defined in FIG. 6D 1600. The table stats_daily 1735 stores the reference details of courseid, timeend, etc is defined in the table. Its relationship is set to the main course table FIG. 6A 1510 through the link 1730 reference defined in FIG. 6D 1600. The table stats_monthly 1740 stores the reference details of courseid, timeend, etc is defined in the table. Its relationship is set to the main course table FIG. 6A 1510 through the link 1730 reference defined in FIG. 6D 1600. The table stats_user_daily 1745 stores the reference details of courseid, roleid, etc is defined in the table. Its relationship is set to the main course table FIG. 6A 1510 through the link 1730 reference defined in FIG. 6D 1600. The table stats_user_monthly 1750 stores the reference details of courseid, timeend, etc is defined in the table. Its relationship is set to the main course table FIG. 6A 1510 through the link 1730 reference defined in FIG. 6D 1600.

FIG. 6H further illustrates the tables which are related to the key table of course and other tables and the relationships between them, and other tables in the LMS. Table 1755 refers to main course table FIG. 6A 1510. The link branch is defined in FIG. 6D 1600. The table stats_user_weekly table 1760 stores the reference details of courseid, roleid, etc is defined in the table. Its relationship is set to the main course table FIG. 6A 1510 through the link 1755 reference defined in FIG. 6D 1600. The table stats_weekly 1765 stores the reference details of courseid, timeend, etc is defined in the table. Its relationship is set to the main course table FIG. 6A 1510 through the link 1755 reference defined in FIG. 6D 1600. The table tool_recyclebin_course 1770 stores the reference details of courseid, timecreated, etc is defined in the table. Its relationship is set to the main course table FIG. 6A 1510 through the link 1755 reference defined in FIG. 6D 1600. The table url 1775 stores the reference details of course is defined in the table. Its relationship is set to the main course table FIG. 6A 1510 through the link 1755 reference defined in FIG. 6D 1600. The table workshop 1780 stores the reference details of course is defined in the table. Its relationship is set to the main course table FIG. 6A 1510 through the link 1755 reference defined in FIG. 6D 1600.

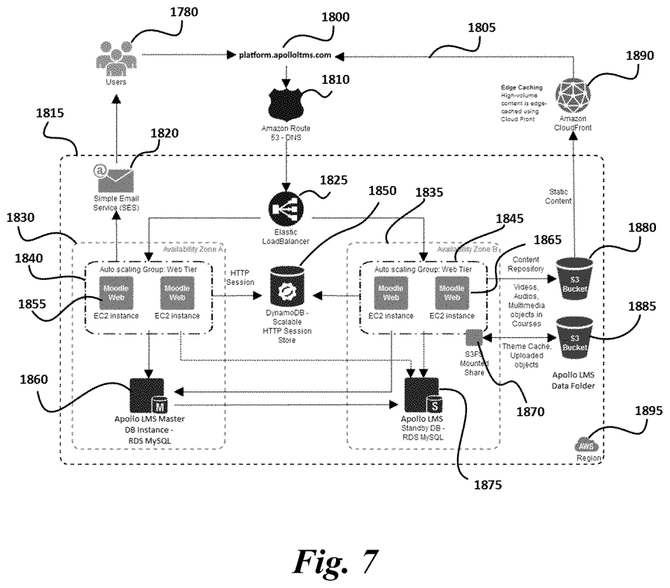

FIG. 7 illustrates the infrastructure supporting the LTMS system in the context in which it is hosted. In one embodiment as illustrated, Amazon Web Services (AWS)® 1815 serves as the hosting infrastructure environment. While FIG. 7 is illustrated using Amazon Web services®, the present invention is not limited to using same and other supporting services may be utilized. In this embodiment, the LTMS software 1800 is hosted on the AWS® infrastructure. Data flows are notionally illustrated by arrows 1805, typical of a plurality of data flows. The LTMS software interacts with users 1780, and its data is carried on so-called forward-deployed instances 1890 of the AWS® storage systems 1880 and 1885. The AWS® infrastructure is comprising a nested cascade of software subsystems, divided into replicated availability zones 1830 and 1835, accessed through a load balancer 1825. The availability zones are interoperating through a scalable HTTP session subsystem 1850. One availability zone 1830 includes a master database instance 1860, which the other availability zone 1835 includes a backup database instance 1875. Each availability zone also includes an auto-scaling group Web tier, 1840 and 1845, containing in turn mobile web instances 1855 and 1865. Data storage is handled using so-called S3 Buckets 1880 and 1885, monitored by a share subsystem 180. The AWS® infrastructure also supports simple email service 1820 for use by LTMS system users. The entire AWS® infrastructure is localized in one or more AWS® regions 1895, appropriate the general location where the LTMS® is being deployed.

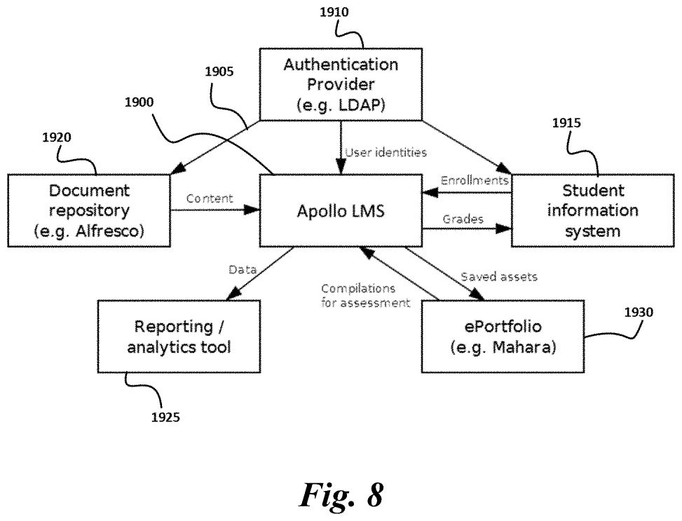

FIG. 8 illustrates the Apollo LMS (LTMS system) 1900 in the context of external services on which it relies for fully integrated operation. In FIG. 8, data flows are notionally illustrated by means of arrows 1905, in a plurality of places. The external services are comprised of LDAP authentication provider 1910, a document repository 1920, a student information system 1915, one or more reporting and analytics tools 1925, and an ePortfolio tool 1930. These external services are not formally part of LTMS but in one embodiment represent the operating environment in which the LTMS operates.

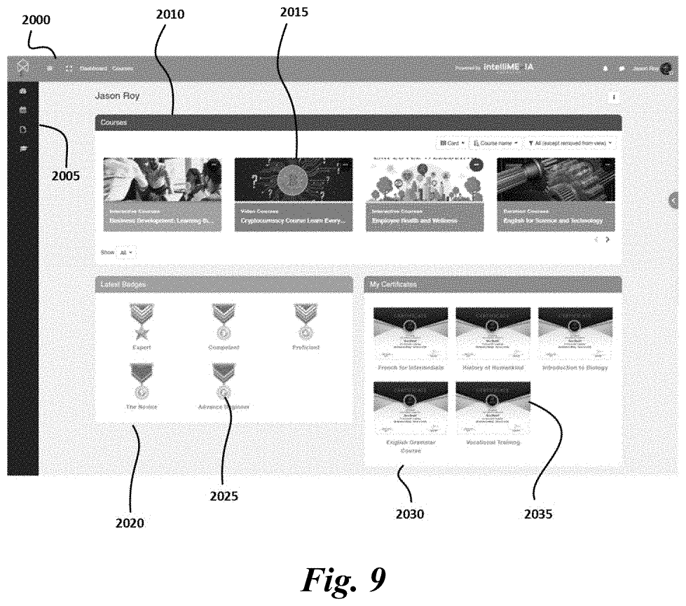

Web-based user interface views of an embodiment of the system are illustrated in FIGS. 9 through 11. FIG. 9 illustrates a user interface dashboard Web page, in a student viewpoint, according to an embodiment. FIG. 9 shows a Web page view of a student dashboard, through which a student participates in use of the system. The user interface is comprising of a header section 2000, a left-side menu 2005, a courses block 2010 showing a plurality of courses including course 2015, a badges block 2020 showing one or more award badges including badge 2025 which the student has earned, and a certificates block 2030 showing one or more graphics including graphics 2035 representing certificates of course completion.

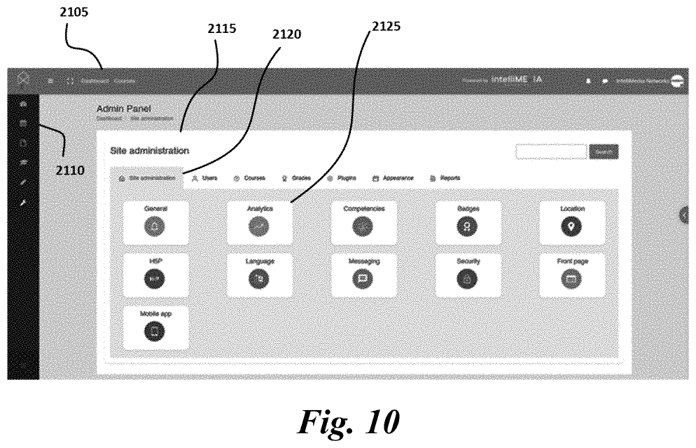

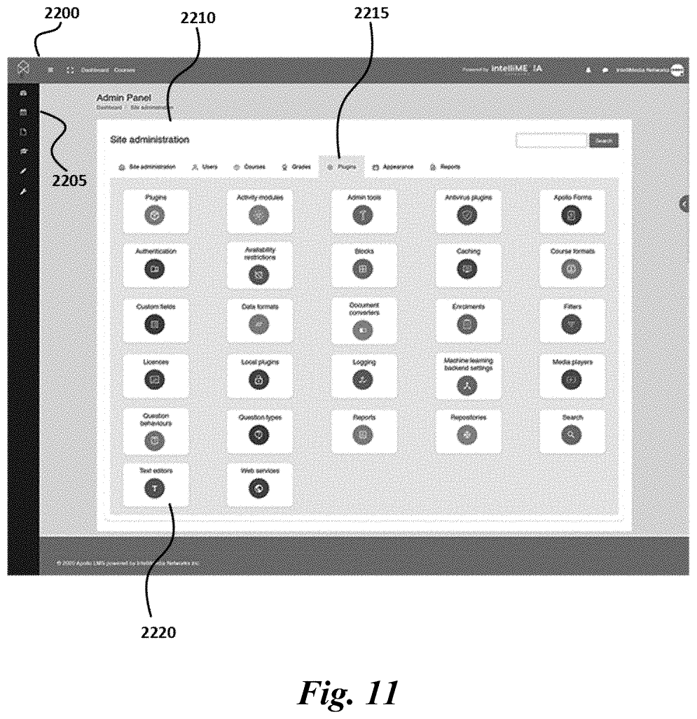

FIGS. 10 and 11 show Web-based user interface views of site administration features and functionalities of the LMS system. This user interface is comprising of a header section 2105, a left-side menu 2110, and a site administration block 2115, comprising in turn a set of tabs, each said tab containing relevant functionality. FIG. 10 shows a site administration tab 2120, containing links to other user interface pages including user interface page 2125 through which various functions can be administered. FIG. 11 in turn illustrates a user interface comprising a header section 2200, a left-side menu 2205, a site administration block 2210, with the tab 2215 highlighted and shown for management of a plurality of plug-ins 2220.

Other Components of the LTMS System

ILA (Immersive Learning App) is a platform supporting a learning process where the student is immersed in a multi-faceted learning environment comprising a combination of natural, simulated, and artificial environmental elements. ILA supports progressive environments guiding the learning experience through a sequence of increasingly complex or challenging situations, enhancing learning rates and facilitating information retention through memorable contexts.

According to an embodiment, the learning process allows content to be shared across multiple different users where one or more of the users is able to provide the other users through a guided view of the content including referring to particular portion(s) of the content, providing additional information pertaining to the content, etc. For example, ILA includes the use of interactive video hotspots which when triggered, lead the student through sequential scenarios.

An ILA subsystem is a framework combining second-screen, social TV, and training applications with a real-time streaming software engine.

Another ILA subsystem provides a centralized communications gateway between tvOS, Roku OS, iOS, and Android OS devices. This subsystem enables inter-process communication between a plurality of devices connected to the system, including services management means, subscriber/subscription data management means, a call server responsible for jointly managing a control plane layer, and at least one distributed media gateway connected to the central software platform by means of a backbone network. The media gateway is responsible for interconnections between the central platform and an external routing center of a communications network of an associated network operator, which in turn is responsible for routing calls to and from communications terminals connected to that communications network.

Another ILA subsystem supports document display overlay on top of video. The overlays can be transparent, translucent, or opaque, and can be modified on-the-fly to suit the requirements of courseware. While video is playing in the user interface, documents and information contained therein can be combined producing an interactive video display referencing content in the video. A method for preparing courseware using this feature can be used in another module of LTMS (i.e., Studio), developing detailed interactions between document components and identifiable video events.

Another ILA subsystem supports Web page (HTML5 class of Web content) materials as an overlay viewable on top of video, or video in combination with overlaid documents. ILA includes the means to collect user input by reference from video, from document overlays, from Web page overlays, and all other elements of the immersive environment, and store such information and act on such information in the context of interactive design of courseware running in the ILA environment.

MRF. MRF (Mixed-Reality Framework) is an augmented-reality system which operates providing a fully immersive audio-visual experience combining virtual and actual realities in instructive ways. The audio-visual system is comprising an immersive video subsystem, and immersive audio subsystem, and data source overlays. The video system creates immersive stereoscopic video images that mix live videos, computer-generated graphic images, and human interactions with the system. The immersive audio subsystem creates immersive sounds with each sound source positioned correctly with respect to the position of an associated element or participant in the video scene.

MRF integrates data and displayed information from dissimilar sources. Operating in the context of a virtual-reality display system together with overlaid data sources displayed within the virtual-reality environment, MRF enables an augmented experience for the student or other system user.

A mobile app generates and manages companion apps in LTMS central memory or the mobile memory of included mobile devices. The companion apps cooperate with one or more tracker apps in memory of a wearable device which displays the virtual environment. One or more of the companion apps communicate with an integrated tracker app providing extended capabilities for the integrated tracker app including connectivity to the Internet to access online content such as services or data. Such online content is passing through to the display in the wearable device display and becoming accessible to the user for viewing or interactive response.

IM. IntelliMeetings (IM) is structured as an application software module of LTMS providing collaborative meeting environments for users through computers, mobile tablets, mobile phones, and other display devices which may be connected through LMS. IM provides an interactive environment where number of individual users can interact which viewing shared content, as well as images of each other. Meeting participant images can be selectively placed controlled anywhere on the screen of each individual user. Video feeds of each participant can be collectively displayed as tiled regions partially or fully covering the display screen of any participating user's device.

IM also includes a conventional array of login/logout mechanisms, communication access protocols and controls, screen controls, audio and video feeds, display controls, and participant meeting management controls.

Apollo Studio. Another module of LTMS is Apollo Studio, operating as a content and courseware creation system for material intended for operation through LTMS. Studio enables creation of interactive courseware, comprising creation and inclusion of static material, video and audio inclusions, interactive problem-solving and testing Web content, and import of external materials and externally created courseware produced by others.

As describe herein, learning and training system provides a combination of software tools and experiences presented to a user in real-time or in a time-shift (on-demand). The system allows for separate and different information sources, learning applications, streaming services, communication/meeting systems, user interactions, queries to be captured and shared on a one-to-one basis or in a one-to-many where content viewing is synchronized while responses or activities by users are individualized.

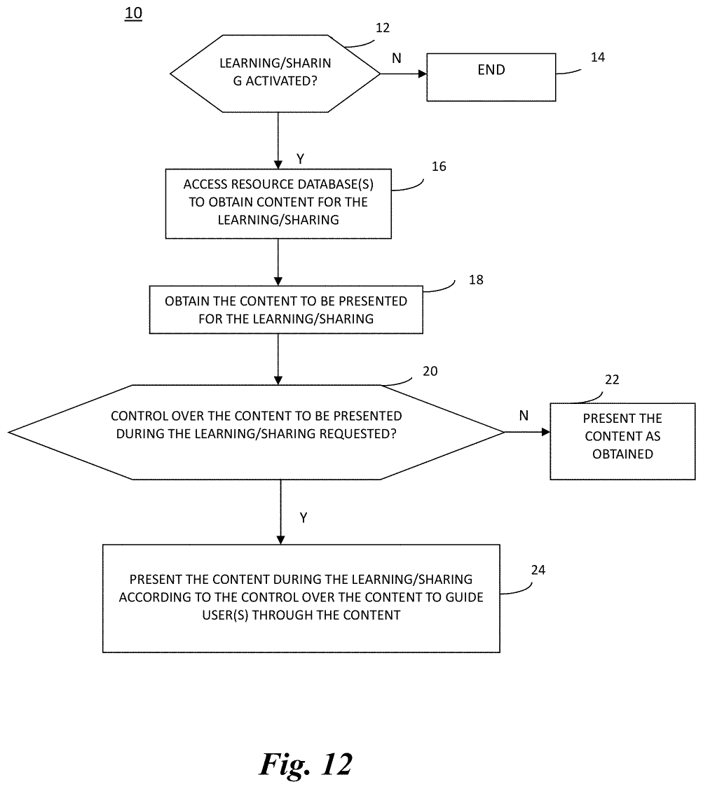

An exemplary control process 10 over content presentation of the system, according to an embodiment is illustrated in FIG. 12.

As shown in FIG. 12, process 10 begins when learning/sharing of the system is activated 12. Subsequent to activation 12 of the learning/sharing, process 10 proceeds to access 16 resource databases (information resources) to obtain content for the learning/sharing or proceeds to end 14 when the learning/sharing has not been activated.

The process 10 may access 16 resource database(s) to obtain content for the learning/sharing or proceeds. According to an embodiment, the present invention may access any resource databases (information resource) including but not limited to external or internal databases, websites, documents, videos, audio files, etc.

Subsequent to accessing 16 the resource database(s), process 10 continues by obtaining 18 the content to be presented for the learning/sharing activating 44 resource(s). The content or information obtained 18 may include but is not limited to text, graphics audio, video, etc.

The process 10 proceeds to determining whether control 20 over the content to be presented during the learning/sharing requested. For example, one or more users participating in the learning/sharing may request control over the content that is to be presented during the learning/sharing. However, the present invention is not limited to the control 20 over the content that is to be presented during the learning/sharing as requested by user(s) and may include a default control over the content based on the type of the content, the learning/sharing format to be presented, etc.

The control 20 over the content to be presented during the learning/sharing requested in process 10 may generate customizable training components which provide integrated and functionally interoperating interactive computer displays, document overlays, streaming videos, Webpage overlays, over-the-top TV overlays, etc.

The process 10 proceeds to present 22 the content as obtained when determining control 20 over the content to be presented during the learning/sharing is not requested.

Subsequent to determining that the control 20 over the content to be presented during the learning/sharing is requested, the process 10 presents 24 the content during the learning/sharing according to the control over the content to guide user(s) through the content.

At presenting 24 of the process 10, the content is presented during the learning/sharing in a controlled or guided manner. For example, one or more users are is presented 24 with the content by being guided though the content according to document overlays, streaming videos, audio, etc.

According to an embodiment, the presenting 24 of the content during the learning/sharing according to the control over the content to guide user(s) through the content may allow users interact independently from each other. For example, during the learning/sharing, the content may be presented 24 to allow viewers to interact independently from each other where some could watch (but others can go to additional information) on what's being presented. In this regard, viewers of the presented 24 content are provided with capability for experience that includes viewing, navigation, interacting, commenting, and responding.

A program/software implementing the embodiments may be recorded on a computer-readable media, e.g., a non-transitory or persistent computer-readable medium. Examples of the non-transitory computer-readable media include a magnetic recording apparatus, an optical disk, a magneto-optical disk, and/or volatile and/or non-volatile semiconductor memory (for example, RAM, ROM, etc.). Examples of the magnetic recording apparatus include a hard disk device (HDD), a flexible disk (FD), and a magnetic tape (MT). Examples of the optical disk include a DVD (Digital Versatile Disc), DVD-ROM, DVD-RAM (DVD-Random Access Memory), BD (Blue-ray Disk), a CD-ROM (Compact Disc-Read Only Memory), and a CD-R (Recordable)/RW. The program/software implementing the embodiments may be transmitted over a transmission communication path, e.g., a wire and/or a wireless network implemented via hardware. An example of communication media via which the program/software may be sent includes, for example, a carrier-wave signal.

The many features and advantages of the embodiments are apparent from the detailed specification and, thus, it is intended by the appended claims to cover all such features and advantages of the embodiments that fall within the true spirit and scope thereof. Further, since numerous modifications and changes will readily occur to those skilled in the art, it is not desired to limit the inventive embodiments to the exact construction and operation illustrated and described, and accordingly all suitable modifications and equivalents may be resorted to, falling within the scope thereof.

What is claimed is:

1. A system for an integrated learning and training management for improved user experience, the system comprising:
at least one processor; and
at least one memory to store instructions to cause the at least one processor to:
coordinate and control one or a plurality of server-based and user-facing modules of the system which operate on a cloud-based core software infrastructure;
manage software tools enabling administrative users of the system and teachers using the system to manage courses offering through the system;
integrate one or a plurality of immersive learning applications, providing integrated and functionally interoperating interactive computer displays, document overlays, streaming video, Webpage overlays, and over-the-top TV overlays;
manage a mixed-reality framework, combining user virtual-reality experiences with actual reality experiences and displaying of courseware materials;
manage a communications software framework enabling online video meetings among multiple parties viewing and interacting with shared or distinct courseware materials or other viewable materials, in full-screen tiled or partial screen tiled or layer-stacked displayed;
enable development and posting of complex course materials by teachers and other qualified individuals or entities;
store shared resources accessible to users of the system, said resources being viewable through display features of the system; and
control access to and sharing of stored data filtered by access criteria with administrators or teachers or learners, or other system users setting such criteria.

2. The system of claim 1, wherein the at least one processor is configured to:
provide one or a plurality of semantic search algorithms accessible to the user enabling searching for business intelligence or other materials of value to the user; and
control one or a plurality of ontologies stored in LTMS databases, by which semantic searches are guided; and
provide semi-autonomous software agent processes continuously evolving and improving said one or the plurality of semantic search algorithms and said one or the plurality of ontologies.

3. The system of claim 1, wherein multiple instances of the system of claim 1, or any component parts thereof, comprising features including:
the said multiple instances sharing data,
the said multiple instances sharing common values of operating parameters,
the said multiple instances sharing patterns of operation, and the said multiple instances operating independently or in coordination with each other.
